(19) United States
(12) Patent Application Publication
(10) Pub. No.: US 2012/0278538 A1
(43) Pub. Date: Nov. 1, 2012

(54) DATA STORAGE APPARATUS, MEMORY CONTROL DEVICE, AND METHOD FOR CONTROLLING FLASH MEMORIES

(75) Inventors: Takahiro Nango, Hino-shi (JP); Hiroyuki Moro, Hachioji-shi (JP); Motohiro Matsuyama, Hino-shi (JP); Kiyotaka Iwasaki, Kawasaki-shi (JP)

(73) Assignee: KABUSHIKI KAISHA TOSHIBA, Tokyo (JP)

(21) Appl. No.: 13/421,618

(22) Filed: Mar. 15, 2012

(30) Foreign Application Priority Data
Apr. 26, 2011 (JP) 2011-098532

(51) Int. Cl. G06F 12/00

(52) U.S. Cl. 711/103; 711/E12.008

(57) ABSTRACT

According to one embodiment, a data storage apparatus includes a memory module and a controller. The memory module has a plurality of flash memory chips. Data is written to or read from each flash memory chip having a specific page size as access unit. The controller is configured to supply memory control signals, which are independent of the common signal containing the data and addresses, to the flash memory chips, respectively, in order to write data larger than the specific data size to the memory module. In the memory module, the respective flash memory chips store the data, each at the same address, in response to the memory control signals.

### CROSS-REFERENCE TO RELATED APPLICATIONS

This application is based upon and claims the benefit of priority from prior Japanese Patent Application No. 2011-098532, filed Apr. 26, 2011, the entire contents of which are incorporated herein by reference.

### FIELD

Embodiments described herein relate generally to a data storage apparatus having flash memories used as storage media, to a memory control device, and to a method for controlling flash memories.

### BACKGROUND

In recent years, solid-state drives (SSDs) have been developed as data storage devices using NAND flash memories (hereinafter referred to as “flash memories” in some cases) that are rewritable nonvolatile memories.

In most SSDs, data is written to or read from each flash memory chip in access units called “physical pages.” A physical page has a size of, for example, 4 kilobytes. This size is larger than the sector size (e.g., 512 bytes), which is the file management unit in host computers.

In an SSD, access units known as “physical pages” are used with respect to each flash memory chip. If the flash memory chip has a page capacity smaller than the physical page size, a write control should be performed to distribute the physical page to two or more flash memory chips.

To distribute the physical page to a plurality of flash memory chips, the flash memory chips must be controlled independently. Consequently, the write time will increase, ultimately decreasing the performance of the SSD.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing the configuration of a data storage apparatus according to any embodiment;

FIG. 2 is a block diagram showing the configuration of the memory access controller used in a first embodiment;

FIG. 3 is a flowchart explaining how the memory access controller operates in the first embodiment;

FIGS. 4A, 4B, 4C, 4D, 4E, 4F, 4G, 4H, 4I, 4J and 4K are a timing chart explaining the write operation performed in the first embodiment;

FIGS. 5A, 5B, 5C, 5D, 5E, 5F, 5G, 5H, 5I, 5J, 5K, 5L, 5M, 5N, 5O, 5P 5Q and 5R are a timing chart explaining the read operation performed in the first embodiment;

FIG. 6 is a block diagram showing the configuration of the memory access controller used in a second embodiment;

FIGS. 7A, 7B, 7C, 7D, 7E, 7F, 7G, 7H and 7I are a timing chart explaining the data accessing during the write operation performed in the second embodiment;

FIGS. 8A, 8B, 8C, 8D, 8E, 8F, 8G, 8H, 8I and 8J are a timing chart explaining the write operation performed in the second embodiment;

FIGS. 9A, 9B, 9C, 9D, 9E, 9F, 9G, 9H, 9I and 9J are a timing chart explaining the read operation performed in the second embodiment;

FIGS. 10A, 10B and 10C are diagrams explaining a first method of using the flash memories in any embodiment;

FIGS. 11A, 11B and 11C are diagrams explaining a second method of using the flash memories in any embodiment;

FIGS. 12A, 12B and 12C are diagrams explaining a third method of using the flash memories in any embodiment;

FIGS. 13A, 13B and 13C are diagrams explaining a fourth method of using the flash memories in any embodiment; and

FIGS. 14A, 14B and 14C are diagrams explaining a fifth method of using the flash memories in any embodiment.

### DETAILED DESCRIPTION

Various embodiments will be described hereinafter with reference to the accompanying drawings.

In general, according to one embodiment, a data storage apparatus includes a memory module and a controller. The memory module has a plurality of flash memory chips. Data is written to or read from each flash memory chip having a specific page size which is an access unit. The controller is configured to supply memory control signals, which are independent of the common signal containing the data and addresses, to the flash memory chips, respectively, in order to write data larger than the specific data size to the memory module. In the memory module, the respective flash memory chips store the data, each at the same address, in response to the memory control signals.

[Configuration of the Data Storage Apparatus]

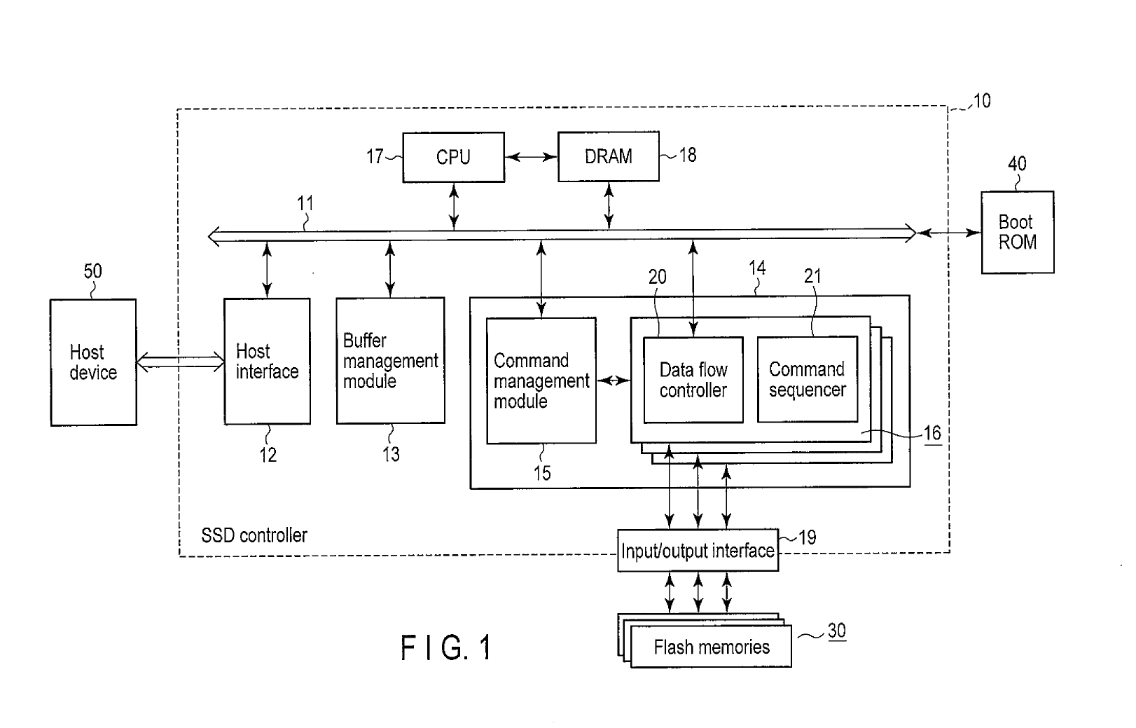

FIG. 1 is a block diagram showing the configuration of a data storage apparatus according to any embodiment.

As seen in FIG. 1, the data storage apparatus is a solid state drive (SSD) comprising a SSD controller 10, a NAND flash memory module (hereinafter referred to as “flash memory module”) 30, and a boot read only memory (ROM) 40.

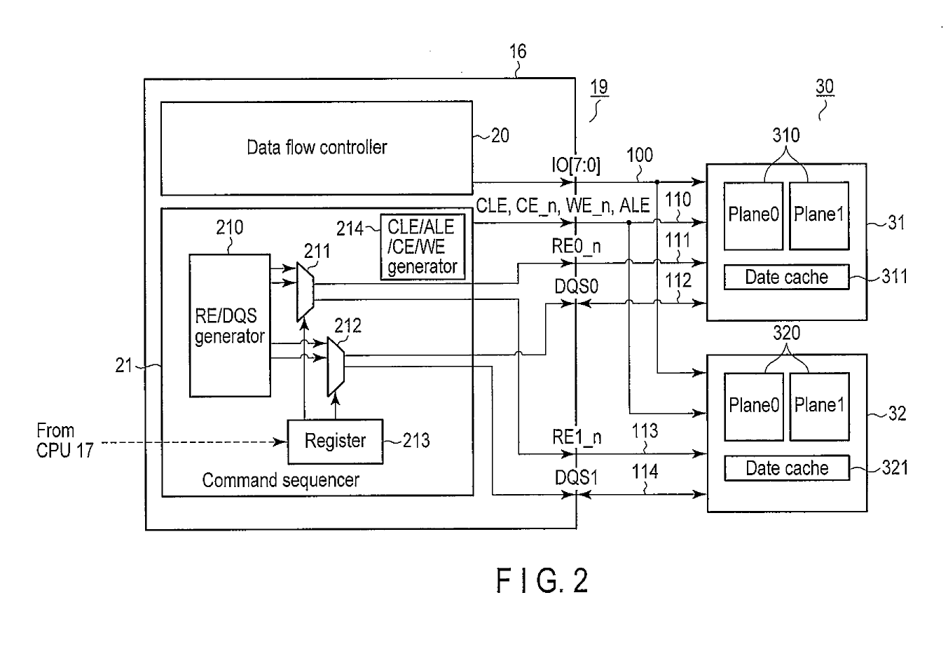

The flash memory module 30 is the data storage medium of the SSD. The flash memory module 30 can be connected to the SSD controller 10 in units of channels or packages. For convenience, as shown in FIG. 2, two flash memory chips 31 and 32 are connected, in unit of channels, to the SSD controller 10 in the data storage apparatus of FIG. 1. The memory area of the flash memory chips 31 is logically divided into two memory areas 310 or plane 0 and plane 1. The memory area of the flash memory chip 32 is logically divided into two tow memory areas 320, or plane 0 and plane 1. The flash memory chips 31 and 32 include a data cache 311 and a data cache 321, respectively.

As shown in FIG. 1, the boot ROM 40, which is provided outside the SSD controller 10, is connected to the internal bus 11 of the SSD. When the SSD is turned on, the boot ROM 40 supplies the software for operating the microprocessor (CPU) 17 incorporated in the SSD controller 10. The software is transferred to the internal memory of the CPU 17 or the dynamic random access memory (DRAM) 18 incorporated in the SSD controller 10, and is stored in the internal memory or the DRAM 18. Thus, the boot ROM 40 enables a host device 50 to access the SSD.

The SSD controller 10 has a host interface 12, a buffer management module 13, a flash memory controller 14, and an input/output interface 19, in addition to the internal bus 11, CPU 17 and DRAM 18.

The CPU 17 controls the other components of the SSD controller 10. The DRAM 18 functions as main memory the CPU 17 accesses, and holds a logic/physical address conversion table and the data transferred from the host device 50.

The host interface 12 controls the transfer of data, commands and addresses between the host device 50 and the SSD controller 10. The host device 50 uses a logic address (i.e., logical block address [LBA]), making an access to the SSD controller 10. The host device 50 is an interface controller conforming to, for example, the Serial ATA (SATA) standard, which is incorporated in a host system (computer).

The buffer management module 13 controls the DRAM 18, ultimately controlling the data transfer between the host interface 12 and the buffer memory (i.e., DRAM 18). The buffer management module 13 also controls the data transfer between the flash memory controller 14 and the buffer memory (i.e., DRAM 18).

The flash memory controller 14 includes a command management module 15 and flash memory access controllers (hereinafter referred to as “memory access controllers”) 16. The command management module 15 performs command management to control the execution of a write command and a read command, both set by the CPU 17. Further, the command management module 15 performs table management to control, for example, the logic/physical address conversion table. To write data to the flash memory module 30, the command management module 15 issues a write command to the memory access controllers 16. To read data from the flash memory module 30, the command management module 15 issues a read command to the memory access controllers 16.

The memory access controllers 16 are provided for the channels, respectively, and control the writing and reading data to and from the flash memory module 30 and also the data transfer between the flash memory module 30 and the SSD controller 10. As shown in FIG. 2, each memory access controller 16 includes a data flow controller 20 and a command sequencer 21. The data flow controller 20 is an interface controller configured to control the data transfer between the flash memory module 30 and the buffer memory (DRAM 18), while handshaking with the buffer management module 13. To write data to the flash memory module 30, the data flow controller 20 sends a write-data transfer request to the buffer management module 13. In response to the write-data transfer request, the buffer management module 13 transfer the data stored in the DRAM 18 to the data flow controller 20. The data flow controller 20 receives the data received from the buffer management module 13, and outputs the data to the data path 100 of the input/output interface 19.

The command sequencer 21 issue a command to select one of the flash memory chips (i.e., two chips 31 and 32 in this embodiment) included in the flash memory module 30, and a command to make access to the flash memory chip selected. As seen in FIG. 2, the command sequencer 21 generates various memory control signals to access the flash memory chips 31 and 32, and supplies these control signals to the control signal paths 110 to 114 of the input/output interface 19.

### First Embodiment

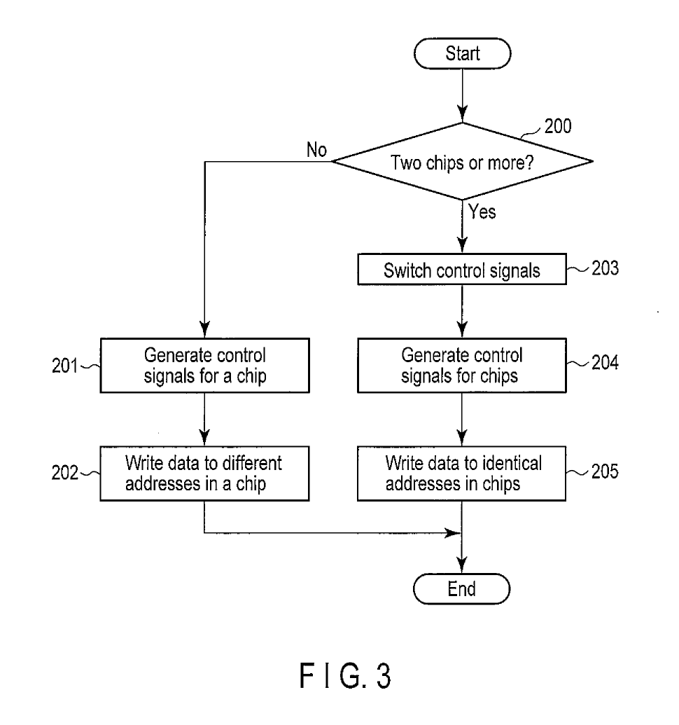

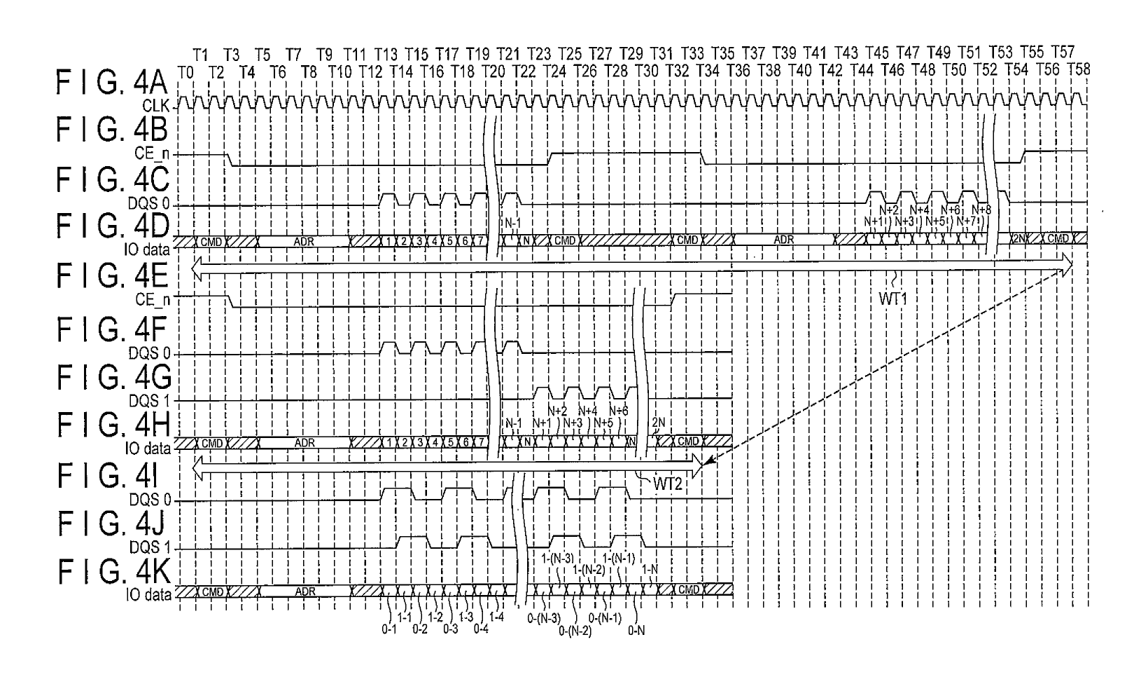

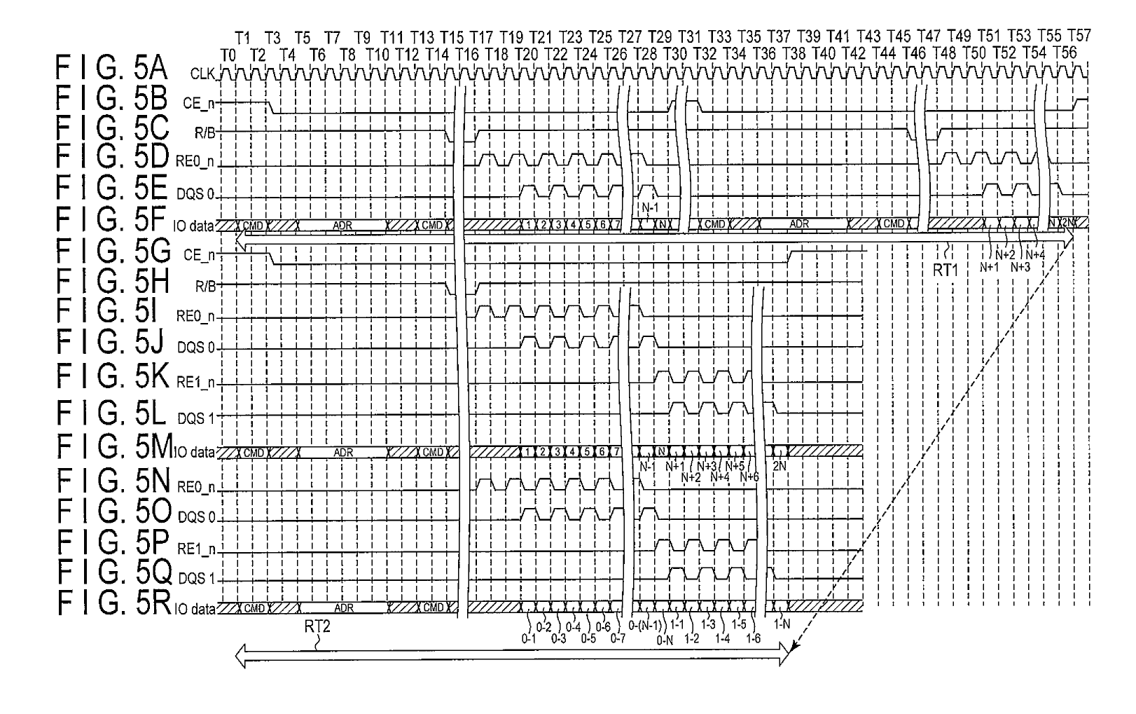

How the flash memory chips are controlled in the first embodiment will be explained with reference to FIG. 2, FIG. 3, FIGS. 4A to 4K and FIGS. 5A to 5R. FIG. 2 is a block diagram showing the configuration of the memory access controller 16.

In the memory access controller 16, the data flow controller 20 receives the data (hereinafter called “IO data” on some occasions) coming from the buffer management module 13 and transfers this data to the data path 100 of the input/output interface 19. The command sequencer 21 generates various memory control signals, which are sent to the control signal paths 110 to 114 of the input/output interface 19.

The memory control signals include a command latch enable signal CLE, a chip enable signal CE, a write enable signal WE, and an address latch enable signal ALE. The memory control signals also include a ready-or-busy signal R/B (see FIG. 5H).

The memory control signals further include a read enable signal RE0_n, which is supplied to the first flash memory chip 31 so that data may be read from the first flash memory chip 31, and a data strobe DQS0 which is supplied to the first flash memory chip 31 so that data may be written to the first flash memory chip 31. To read data, data strobe DQS0 is output from the first flash memory chip 31.

Still further, the memory control signals include a read enable signal RE1_n, which is supplied to the second flash memory chip 32 so that data may be read from the second flash memory chip 32, and a data strobe DQS1 which is supplied to the second flash memory chip 32 so that data may be written to the second flash memory chip 32. To read data, data strobe DQS1 is output from the second flash memory chip 32.

The command sequencer 21 has an RE/DQS generator 210, selectors 211 and 212, a register 213, and a CLE/ALE/CE/WE generator 214. The RE/DQS generator 210 generates above-mentioned read enables RE0_n and RE1_n and also above-mentioned data strobes DQS0 and DQS1. The CLE/ALE/CE/WE generator 214 generates the above-mentioned command latch enable signal CLE, address latch enable signal ALE, chip enable signal CE and write enable signal WE, all mentioned above.

The register 213 is set to the value notified by the CPU 17 and representing the number of chips connected to the memory access controller 16. This value has been calculated by the CPU 17 based on the size (M) of the physical page to write data to the flash memory module 30 in one access thereto.

To write data, the command sequencer 21 supplies data strobes DQS0 and DQS1 at the same time via the selectors 211 and 212 to the first and second flash memory chips 31 and 32, respectively, in accordance with the number of chips (i.e., “2”) set in the register 213. To read data, the command sequencer 21 supplies read enable signals RE0_n and RE1_n at the same time via the selectors 211 and 212 to the first and second flash memory chips 31 and 32, respectively, in accordance with the number of chips (i.e., “2”) set in the register 213.

In the basic operating mode of the SSD, the CPU 17 set the number of chips connected to the memory access controller 16, i.e., “1,” to the register 213. Hence, to write data, the command sequencer 21 supplies data strobe DQS0 or DQS1 to the first flash memory chip 31 or second flash memory chip 32. To read data, the command sequencer 21 supplies read enable signal RE0_n or read enable signal RE1_n to the first flash memory chip 31 or second flash memory chip 32.

(Memory Control)

How the memory access controller 16 operates to write data will be explained with reference to the flowchart of FIG. 3 and the timing chart of FIGS. 4A to 4K.

To write data, the command management module 15 issues a write command to the memory access controller 16, in accordance with the instructions it has received from the CPU 17. The data flow controller 20 receives the data (IO data) stored in the buffer memory (DRAM 18) through the buffer management module 13, and transfers this data to the data path 100 of the input/output interface 19. This data, i.e., write data, is output from the input/output interface 19 via the data path 100 to the flash memory module 30.

The flash memory module 30 stores the data in response to the memory control signals output from the command sequencer 21. The memory control signals are supplied to the flash memory module 30 through the control signal paths 110 to 114 of the input/output interface 19. In this embodiment, the command sequencer 21 switches the memory control signals, from one to another, in accordance with the number of flash memory chips the flash memory module 30 has, as shown in FIG. 3 (Block 203).

If the number of chips, set in the register 213 of the command sequencer 21, is “1,” the memory access controller 16 performs the basic write operation (NO in Block 200). In the basic write operation, the command sequencer 21 supplies data strobe DQS0 generated by the RE/DQS generator 210 via the selector 212, to the first flash memory chip 31 (Block 201). The command sequencer 21 also supplies a memory control signals other than data strobe DQS0 to the first flash memory chip 31 through the control signal path 110.

FIGS. 4B to 4D are a timing chart explaining the basic write operation. More precisely, FIG. 4A shows a clock signal CLK, which is a timing signal for the write operation performed in this embodiment. FIG. 4B shows chip enable signal CE_n. FIG. 4D shows the write data (IO data) 100 output from the data flow controller 20. The IO data contains not only user data (1 to 2N), but also commands (CMD) and addresses (ADR). Of the IO data item shown in FIGS. 4D, 4H and 4K, the shaded parts are invalid data (as in FIGS. 5F, 5M, 5R, FIG. 8I and FIG. 9I discussed herein later).

In the basic write operation, the memory access controller 16 adjusts data strobe DQS0 generated by the command sequencer 21, so that the rising and falling edges may align with the mid part of the data output from the data flow controller 20 as is illustrated in FIGS. 4C and 4D. The data output from the data flow controller 20 is supplied to the data cache 311 of the flash memory chip 31.

Assume that the write command issued from the command management module 15 designates a physical page (M bytes) is twice as large as the physical page (N bytes) of the flash memory chips 31 and 32 (that is, M=2N). Thus, the flash memory chips 31 and 32 have a physical page size of N bytes which is an access unit to write.

In the basic write operation, the memory access controller 16 controls data in units of 2N (i.e., two physical pages in the flash memory chip 32) in the command phase, address phase and write time (WT1) as shown in FIG. 4D (Block 202). That is, any data having a physical page size (M bytes) larger than N bytes is distributed to different addresses in one flash memory chip 31. To write such data, the write time (WT1) is twice as long as the time for writing N bytes.

If the number of chips, set in the register 213 of the command sequencer 21, is “2,” the memory access controller 16 performs the write operation according to this embodiment (YES in Block 200, Block 203). In this case, the command sequencer 21 controls the selector 212, whereby data strobes DQS0 and DQS1 are supplied to the flash memory chips 31 and 32, respectively (Block 204). The command sequencer 21 also supplies memory control signals other than data strobes DAS0 and DAS1 to the two flash memory chips 31 and 32 through the control signal path 110.

A method of determining the number of memory chips that should be connected to the SSD controller 10 will be described. In the SSD according to the embodiment, one physical page, i.e., an access unit in both the write operation and the read operation, has a size of M bytes, whereas each flash memory chip (31 or 32) that can be connected, as flash memory module 30, to the SSD controller 10 has a size of N byte (N<M).

The CPU 17 calculates the number Z of chips connected to the SSD controller 10, by using the equation of: Z=M/N. The CPU 17 sets the number Z (Z=2) to the register 213 of the command sequencer 21. The number Z may not have an integral value, or a plurality of N-byte chips may not be provided. If this is the case, measures are taken as will be described herein later in [Physical Page Size and Use of Flash Memory Chips].

FIG. 4E to FIG. 4H are timing chart explaining the write operation performed in this embodiment. FIG. 4E shows a chip enable signal CE_n, and FIG. 4H shows the write data (IO data) output from the data flow controller 20.

If the number of chips connected, set in the register 213, is “2,” the command sequencer 21 controls the selector 212, supplying data strobes DQS0 and DQS1 generated by the RE/DQS generator 210, to the flash memory chips 31 and 32, respectively. Further, the command sequencer 21 supplies two memory control signals other than data strobes DQS0 and DQS1 to the flash memory chips 31 and 32, respectively, through the control signal path 110.

More specifically, as shown in FIG. 4F and FIG. 4G, the RE/DQS generator 210 generates data strobes DQS0 and DQS1 in the toggle cycle that is synchronous with the base write operation. The command sequencer 21 counts the toggles, and outputs data strobes DQS0 and DQS1 in the first toggle phase and the latter toggle phase, respectively.

Therefore, as shown in FIG. 4F and FIG. 4H, the first half of the physical page (M bytes), i.e., N bytes (=M/2 bytes), is written to the flash memory chip 31, while as shown in FIG. 4G and FIG. 4H, the latter half of the physical page (M bytes), i.e., N bytes (=M/2 bytes), is written to the flash memory chip 32. In this case, the data flow controller 20 supplies the write data (IO data) to the flash memory chips 31 and 32, as it performs the same process as in the basic write operation.

Thus, the data of physical page size (M=2N bytes) larger than the physical page size (N bytes) of each flash memory chip is written to two flash memory chips 31 and 32 in one access. In this case, the memory access controller 16 controls the write data so that the halves of one physical page (M bytes) may be written to the identical addresses of the flash memory chips 31 and 32, respectively (Block 205).

Hence, in the write operation in this embodiment, two N-byte data units, i.e., data of physical page size (M=2N bytes), can be written in one-unit write time (WT2) as shown in FIG. 4H. In the basic write operation, two-unit write time (WT1) is must be used to write one N-byte data unit as shown in FIG. 4D.

FIGS. 5A to 5R are a timing chart explaining how the memory access controller 16 operates during the read operation. In the read operation, the command management module 15 issues a read command to the memory access controller 16 in accordance with the instructions it has received from the CPU 17.

FIG. 5B to 5F are a timing chart of the basic read operation. More precisely, FIG. 5A shows a clock signal CLK, which is a timing signal for the basic read operation and for the read operation performed in this embodiment. (The read operation will be explained later.) FIG. 5B shows chip enable signal CE_n. FIG. 5C shows the ready-or-busy signal R/B. FIG. 5D shows read enable signal RE0_n. FIG. 5E shows data strobe DQS0, which is output from the first flash memory chip 31 in the read operation. FIG. 5F shows read data (IO data) read from the first memory chip 31.

If the number of chips, set in the register 213 of the command sequencer 21, is “1,” the memory access controller 16 performs the basic read operation. In the basic write operation, the command sequencer 21 supplies read enable signal REO_n generated by the RE/DQS generator 210, to the flash memory chip 31. The memory access controller 16 receives data strobe DQS0 and the read data (IO data) from the flash memory chip 31.

That is, in the basic read operation, the memory access controller 16 controls two data units of 1N (i.e., one physical page in the flash memory chip 31) in the command phase, address phase and read time (RT1) as shown in FIG. 5F. That is, a read time (RT1) twice as long as the time for writing N bytes is necessary to read any data having a physical page size (M bytes) larger than N bytes, i.e., in an access unit of the flash memory chip 31.

FIG. 5G to 5M are timing chart explaining the read operation performed in this embodiment. In the read operation, data of physical page size (M=2N bytes) larger than the physical page size (N bytes) of each flash memory chip is read from the identical addresses of two flash memory chips 31 and 32 in one access. In this case, the command sequencer 21 counts the toggles, and outputs read enable signal RE0_n, in the form of the first half and the latter half.

Thus, in this embodiment, data of physical page size larger than the physical page size (N bytes) of each flash memory chip can be written to, or read from, a plurality of flash memory chips, in one access, irrespective of the physical size of the flash memory chips provided in the flash memory module 30. In other words, data can be written to, or read from, a plurality of flash memory chips in one access. This prevents a decrease in access performance of the SSD and can increase the size of one physical page. Since data of a physical page is written to a plurality of flash memory chips in one access, the embodiment can provide an SSD to which data can be written in a short time.

### Modified Embodiment

FIGS. 4I to 4K are a timing chart explaining the write operation according to a modification of the present embodiment. In the write operation of the modified embodiment, the RE/DQS generator 210 of the memory access controller 16 generates data strobes DQS0 and DQS1 that differ in toggle cycle.

To be more specific, the RE/DQS generator 210 generates data strobes DAQ0 and DQS1 that toggle at the rising and falling edges at two-cycle intervals as shown in FIGS. 4I and 4J. If the number of chips, set in the register 213 of the command sequencer 21, is “2,” the command sequencer 21 controls the selector 212, outputting data strobes DQS0 and DQS1 generated by the RE/DQS generator 210. The input/output interface 19 supplies data strobes DQS0 and DQS1 via control signal paths 112 and 114 to the two flash memory chips 31 and 32, respectively.

In the modified embodiment, the data flow controller 20 sorts out data 100 (IO data) having one physical page size of M bytes, and controls the data 100 so that the data may be output in a specified order. The M-byte data is divided into two pages, each being N-byte page. These two N-byte pages are processed by using the two flash memory chips 31 and 32.

The memory access controller 16 thus controls the data. As a result, the first data (0-1), second data (0-2), third data (0-3), . . . of the first half page are written to the first flash memory chip 31, in the order they are mentioned. Similarly, the first data (1-1), second data (1-2), third data (1-3), . . . of the latter half page are written to the first flash memory chip 32, in the order mentioned.

That is, the data flow controller 20 controls the data in the write operation, so that the first data (0-1) of the first half page, the first data (1-1) of the latter half page, the second data (0-2) of the first half page, the second data (1-2) of the latter half page, . . . , and the Nth data (0-N) of the first page, and the Nth data (1-N) of the latter half page are output in the order they are mentioned.

Also in the method of the modified embodiment, data of a physical page size (M=2N bytes), which is larger than one physical page size (N bytes) of either flash memory chip can be thus written to the two flash memory chips 31 and 32 in one access.

FIG. 5N to FIG. 5R are a timing chart explaining the read operation performed in the modified embodiment. In the read operation of the modified embodiment, the timing the RE/DQS generator 210 generates read enable signals RE0_n, RE1_n is identical to the timing in the read operation performed in the first embodiment (see FIG. 5I and FIG. 5K).

Also in the read operation performed in the modified embodiment, data of a physical page size (M=2N bytes) larger than one physical page size (N bytes) of either flash memory chip can be read from the two flash memory chips 31 and 32, in one access from the identical addresses as data is written to the flash memory chips 31 and 32 in the write operation described above. Further, the data can be read in units of half pages in the read operation performed in the modified embodiment.

n the embodiment and modified embodiment described above, the timing of writing data is toggle-controlled, by using both edges of data strobe DQS0 and both edges of data strobe DQS1. The method of controlling the write timing is not limited to this. Rather, the timing may be controlled by using ordinary write enable signals WE.

### Second Embodiment

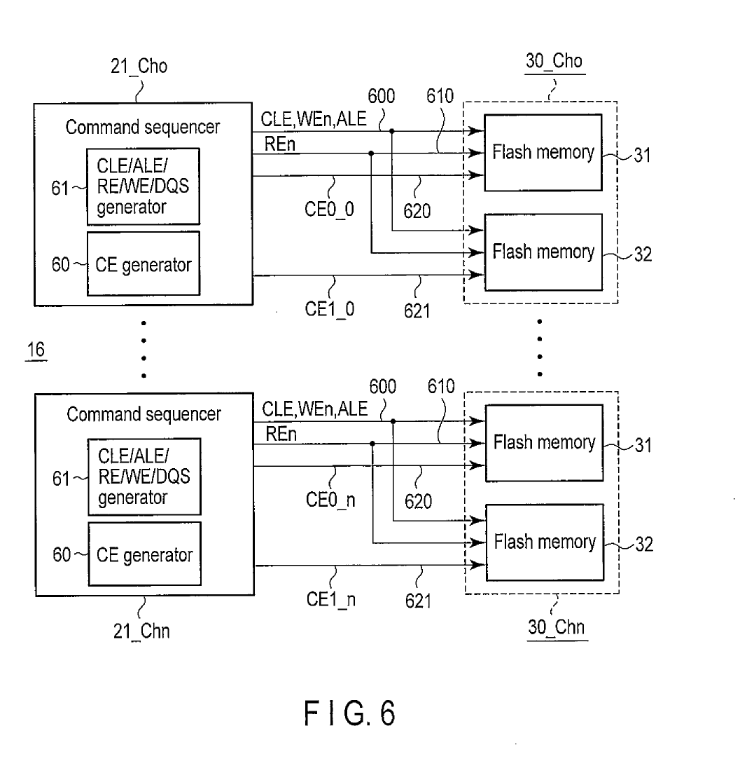

FIG. 6 is a block diagram showing the configuration of the memory access controller 16 used in a second embodiment. Note that the SSD according to the second embodiment has the same configuration as the SSD shown in FIG. 1. Hence, the components of the SSD and their function will not be described.

As described above, the memory access controller 16 are provided for the channels, respectively. FIG. 6 is a diagram showing the components peripheral to command sequencers 21_ch(0) to 21_ch(n), and input/output interface 19 and flash memory modules 30_ch(0) to 30_ch(n). Note that the memory access controllers 16 for the respective channels in the same way. Therefore, only the memory access controller 16 provided for the channel ch(n) will be described as to how it operates.

Command sequencer 21_ch(n) has a chip enable signal generator 60 configured to generate a plurality of chip enable signals, or two chip enable signals CE0_n and CE1_n in this embodiment. Command sequencer 21_ch(n) further has a CEL/ALE/RE/WE/DQS generator 61 configured to generate memory control signals, i.e., a command latch enable signal CLE, an address latch enable signal ALE, a read enable signal REn, a write enable signal WEn, and a data strobe DQS.

Moreover, command sequencer 21_ch(n) outputs a read-or-busy signal R/B. More specifically, command sequencer 21_ch(n) outputs the command latch enable signal CLE, write enable signal WEn and address latch enable signal ALE to the control signal path 600 of the input/output interface 19. Further, command sequencer 21_ch(n) outputs read enable signal REn to a control signal path 610. Still further, command sequencer 21_ch(n) outputs chip enable signals CE0_n and CE1_n to control signal paths 620 and 621, respectively.

(Memory Control)

As has been described with reference to FIG. 1 and FIG. 2, the command management module 15 issues a write command to the memory access controller 16, in accordance with the instructions it has received from the CPU 17, in the write operation. The data flow controller 20 receives data (IO data) from the buffer management module 13 and transfers the data to the data path 100 of the input/output interface 19. The input/output interface 19 outputs this data, i.e., write data via the data path 100 to the flash memory module 30_ch(n).

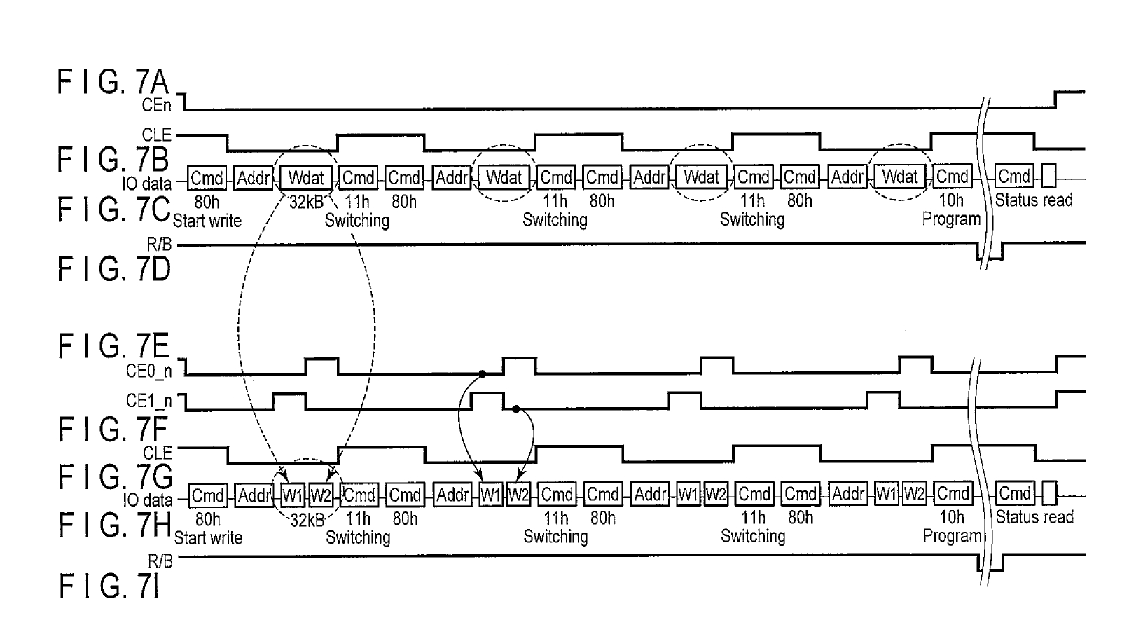

FIGS. 7A to 7I are a chart showing the concept of the chip enabling CE and the data accessing, both performed to write data to the flash memory chips 31 and 32 in the present embodiment.

Assume that 32 kilobytes (M=32 kilobytes) is set in the SSD, as one physical page size that is an access unit in both the write operation and the read operation, and that the flash memory module 30_ch(n) includes the flash memory chips 31 and 32, each having one physical page size is 32 kilobytes. Then, when the memory access controller 16 outputs memory control signals such as chip enable signal (CEn) and command chip enable signal CLE, and outputs write data Wdat of 32 kilobytes, the flash memory chips of the flash memory module 30_ch(n) will store the write data Wdat of 32 kilobytes.

If the flash memory module 30_ch(n) has two flash memory chips 31 and 32, each having a physical page size of 16 kilobytes (N=M/2), one physical page size (i.e., 32 kilobytes) cannot be written to the flash memory module 30_ch(n) unless some measures are taken. Therefore, in this embodiment, the flash memory chips 31 and 32 are used, each having one physical page size of 16 kilobytes, and command sequencer 21_ch(n) outputs two chip enable signals CE0_n and CE1_n, generated by dividing chip enable signal CEn into two segments. This is why the input/output interface 19 the control signal path 621, in addition to the control signal paths 621, in order to transfer chip enable signal CE1_n to the flash memory chip 32.

As shown in FIG. 7E to FIG. 7I, the flash memory chip 31, which receives chip enable signal CE0_n output from command sequencer 21_ch(n), stores the first half W1 of the 32-kilobyte write data Wdat, and the flash memory chip 32, which receives chip enable signal CE1_n output from command sequencer 21_ch(n), stores the latter half W2 of the 32-kilobyte write data Wdat.

In this embodiment, write access to data of 32 kilobytes can be accomplished by dividing chip enable signal CEn into two segments and by using two flash memory chips two flash memory chips, each having one physical page size of 16 kilobytes. In other words, the use of one additional chip enable control signal path renders it possible to perform write operation, in one access, on the flash memory chips for each channel.

That is, even if any flash memory module has more flash memory chips, there is no need to perform additional process on commands, addresses, phases or programs. This helps to shorten the write operation time greatly. The term “program” means the writing of data to the chips of the flash memory module 30.

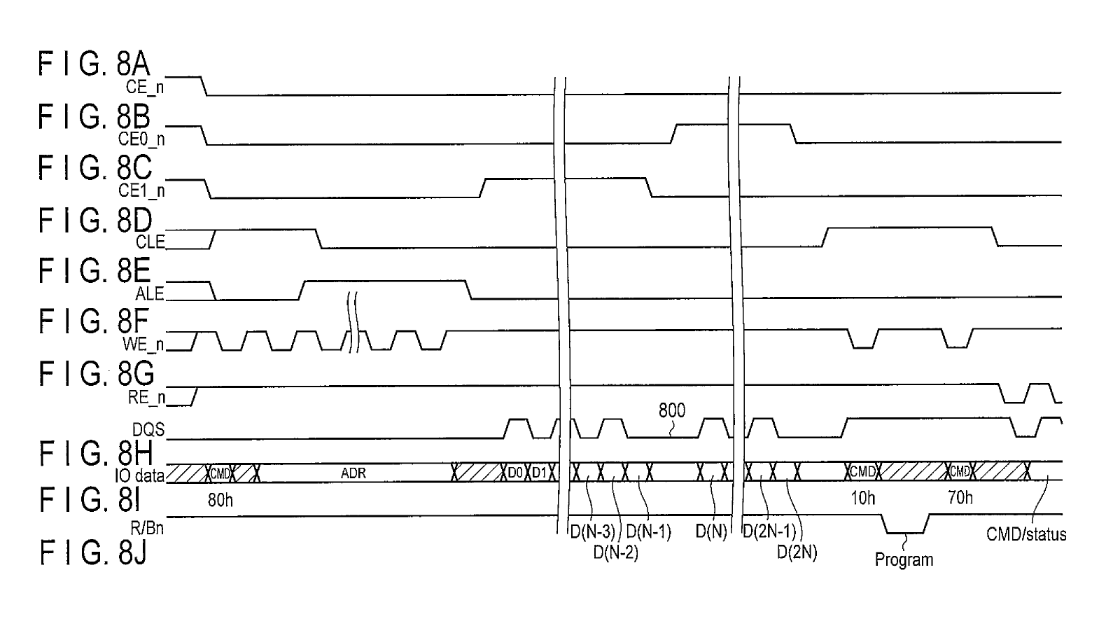

FIGS. 8A to 8J are a timing chart explaining how the write operation of FIG. 7E to FIG. 7I is controlled in the second embodiment. FIGS. 8A to 8J are a magnified version of those parts of FIG. 7E to FIG. 7I, which pertain to command Cmd=80, and explain how to write data to the flash memory chips 31 and 32.

FIG. 8H is a timing chart showing the timing of outputting data strobe DQS (not shown in FIG. 6) generated by the generator 61 that is incorporated in command sequencer 21_ch(n). The memory access controller 16 writes 16-kilobyte data D0-D(N−1), i.e., first half of one physical page (32 kilobytes), to the flash memory chip 31 in response to chip enable signal CE0_n, write enable signal WEn and data strobe DQS.

Further, the memory access controller 16 writes 16-kilobyte data D(N+1)−D(2N), i.e., the latter half of one physical page (32 kilobytes), to the flash memory chip 32 in response to chip enable signal CE1_n and data strobe DQS. As shown in FIG. 8(H), the memory access controller 16 adjusts the timing of outputting data strobe DQS generated by the generator 61 at the time (800) of switching chip enable signal CE0_n to chip enable signal CE1_n. The setup/hold adjustment of the chip enable signal CE and data strobe DQS can thereby be performed even if the frequency increases. The timing of outputting data strobe DQS is adjusted not by a special control circuit, but by command sequencer 21_ch(n), when chip enable signal CE0_n is switched to chip enable signal CE1_n.

(Read Operation)

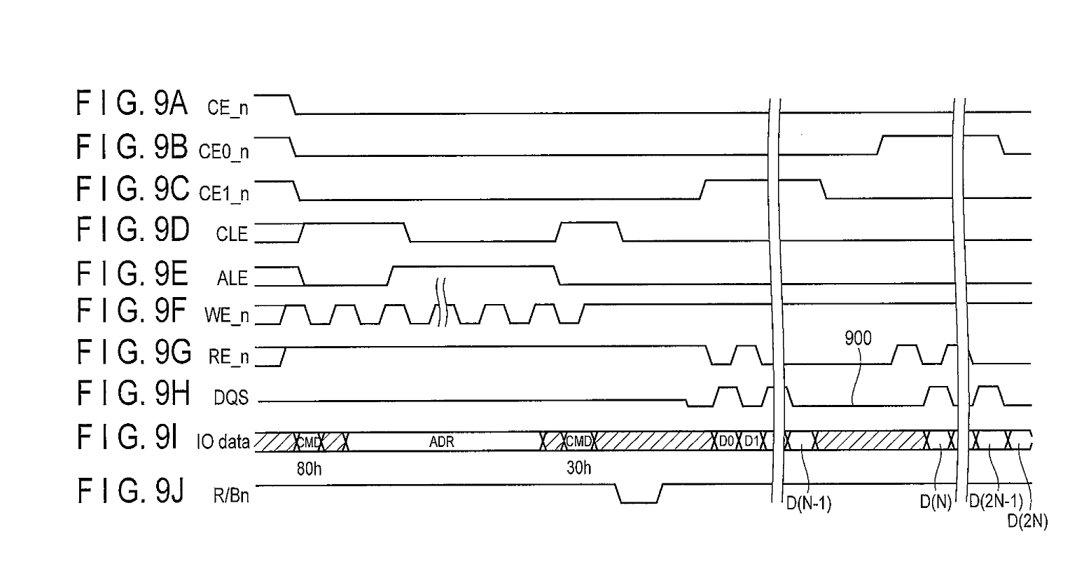

FIGS. 9A to 9J are a timing chart explaining the read operation performed in the second embodiment, to read one physical page (32 kilobytes, i.e., the same amount of data written in the write operation described above) from the flash memory chips 31 and 32.

In response to chip enable signal CE0_n and read enable signal RE_n, the memory access controller 16 reads 16-kilobyte data D0−D(N−1), i.e., first half of one physical page (32 kilobytes), from the flash memory chip 31. In response to chip enable signal CE1_n and read enable signal REn, the memory access controller 16 also reads 16-kilobyte data D(N+1)−D(2N), the latter half of one physical page (32 kilobytes), from the flash memory chip 32.

In the read operation, the timing of outputting data strobe DQS from the memory chips 31 and 32 is adjusted, as shown in FIG. 9H, at the time (900) of switching chip enable signal CE0_n to chip enable signal CE1_n.

In this embodiment, the setup/hold adjustment of the chip enable signal CE and data strobe DQS may be performed not by delaying data strobe DQS. Instead, chip enable control (CE control) may be performed to coordinate chip enable signals CE0_n and CE1_n and data strobe DQS in terms of timing. More precisely, a dual-speed clock signal may be generated in the chip enable signal generator 60 and inverted, and may then be used to adjust the outputting of chip enable signals CE0_n and CE1_n.

[Physical Page Size and Use of Flash Memory Chips]

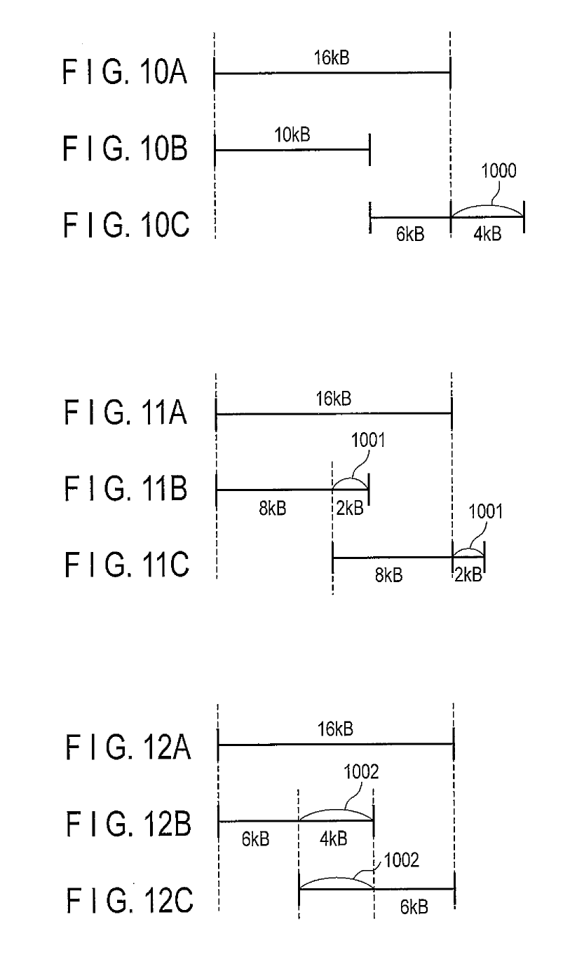

The first and second embodiments describe above use an access method for writing one physical page, which is than the storage capacity of one flash memory chip, to two flash memory chips. FIGS. 10A to 10C, FIGS. 11A to 11C, FIGS. 12A to 12C, FIGS. 13A to 13C and FIGS. 14A to 14C are diagrams explaining, respectively, the first to fifth methods of using two flash memory chips (hereinafter referred to as “chip 1” and “chip 2,” for convenience) in combination.

FIGS. 10A, 11A, 12A, 13A and 14A are identical, each showing the size (i.e., 16 kilobytes) of a physical page that is written in one access. The first to fifth methods will be described below.

In the first method, the two chips 1 and 2 having the same storage capacity (i.e., 10 kilobytes), as shown in FIGS. 10B and 10C, are used in the order mentioned. First, 10-kilobyte data is written to chip 1, and the remaining 6-kilobyte data is then written to chip 2. In this case, 4 kilobytes that are all “0,” i.e., 0-pad, are written to the vacant area 1000 of chip 2.

In the second method, the two chips 1 and 2 having the same storage capacity (i.e., 10 kilobytes), as shown in FIGS. 11B and 11C, are used. First, 8-kilobyte data is written to chip 1. Then, the remaining 8-kilobyte data is written to chip 2. In this case, 2 kilobytes that are all “0,” i.e., 0-pad, are written to the vacant area 1001 of chip 1 and also in the vacant area 1001 of chip 2.

In the third method, the two chips 1 and 2 having the same storage capacity (i.e., 10 kilobytes), as shown in FIGS. 12B and 12C, are used exclusively. More precisely, 10-kilobyte data is written to chip 1, and also to chip 2. Of the 10-kilobyte data written to chip 1, 4-kilobyte data 1002 is used as overlapping data. Similarly, of the 10-kilobyte data written to chip 2, 4-kilobyte data 1002 is used as overlapping data. In the read operation, the data the data 1002 stored in chip 1 is used.

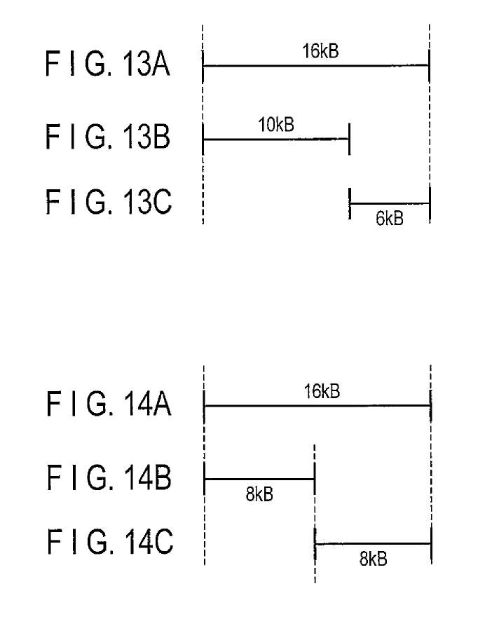

In the fourth method, the two chips 1 and 2 differ in physical page size, as shown in FIGS. 13B and 13C, and hold data of the physical page size (16 kilobytes). More precisely, 10-kilobyte data is written to chip 1 and 6-kilobyte data is written to chip 2.

In the fifth method, the two chips 1 and 2 has the same physical page size of 8 kilobytes, as shown in FIGS. 14B and 14C, and hold data of the physical page size (16 kilobytes). More precisely, 8-kilobyte data is written to chip 1, and other 8-kilobyte data is written to chip 2.

In summary, a memory control can be performed to accomplish an access to data in units of physical pages, not depending on the storage capacity of the flash memory chips used. This moderates the restriction imposed on the size of the flash memory chips used in the SSD, ultimately moderating the design restriction imposed on the SSD controller 10.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage apparatus comprising:
a memory module having flash memory chips each having a prescribed page size as an access unit; and
a controller configured to supply independent memory control signals to the flash memory chips, respectively, thereby to write data at identical addresses in the flash memory chips, the data exceeding the prescribed page size, as an access unit, and the independent memory control signals not included in a common signal containing the data and the addresses.

2. The data storage apparatus of claim 1, wherein the controller is configured to generate, as the memory control signals, data strobes associated with the flash memory chips, respectively, and to supply the data strobes to the flash memory chips, respectively.

3. The data storage apparatus of claim 1, wherein the controller is configured to generate, as the memory control signals, data strobes associated with the flash memory chips, respectively, and different in toggle cycle, and to supply the data strobes to the flash memory chips, respectively.

4. The data storage apparatus of claim 1, wherein the controller is configured to generate, as the memory control signals, data strobes associated with the flash memory chips, respectively, to divide the data into data segments as many as the flash memory chips, and to allocate the data strobes to the data segments, respectively, thereby to write the data segments at the identical addresses in the flash memory chips.

5. The data storage apparatus of claim 1, wherein the controller is configured to determine an order in which to write data segments to the flash memory chips, respectively, so that the data may be read from the memory module in units of access, the data segments having been generated by dividing the data and being the access units.

6. The data storage apparatus of claim 1, wherein the controller is configured to generate, as memory control signals, chip enable signals associated with the flash memory chips, respectively, and to supply the chip enable signals to the flash memory chips, respectively.

7. The data storage apparatus of claim 1, wherein the controller is configured to determine a number of flash memory chips required, from a page size larger than the prescribed page size, and to generate the independent memory control signals in accordance with the number of flash memory chips so determined.

8. The data storage apparatus of claim 1, wherein the controller is configured to write prescribed data in a vacant area of each of the flash memory chips, thereby to write data segments prepared by dividing data of an access unit, to the flash memory chips, respectively.

9. A memory control device for use in a data storage apparatus which has flash memory chips each having a prescribed page size as an access unit and in which data can be written to and read from a memory module including the flash memory chips, the device comprising:
a controller configured to supply independent memory control signals to the flash memory chips, respectively, thereby to write data at identical addresses in the flash memory chips, the data exceeding the prescribed page size, as an access unit, and the independent memory control signals not included in a common signal containing the data and the addresses.

10. A memory control method for use in a data storage apparatus which has flash memory chips each having a prescribed page size as an access unit and in which data can be written to and read from a memory module including the flash memory chips, the method comprising:
generating independent memory control signals not included in a common signal containing data and addresses, in order to write data, as an access unit, to the flash memory module; and
supplying the memory control signals to the flash memory chips, respectively, thereby causing the flash memory chips to store the data at identical addresses.
